(19) United States
(12) Patent Application Publication
(10) Pub. No.: US 2011/0202481 A1
(43) Pub. Date: Aug. 18, 2011

(54) CONSUMER PRODUCT RECOGNITION SYSTEM

(76) Inventors: Julie Karen Lang, Wausau, WI (US); Heather Gayle Lang, Deerfield, WI (US); Paul James Lang, Madison, WI (US)

(21) Appl. No.: 13/093,181

(22) Filed: Apr. 25, 2011

Related U.S. Application Data
(63) Continuation-in-part of application No. 12/220,519, filed on Jul. 25, 2008, now abandoned.

(51) Int. Cl. G06Q 90/00

(52) U.S. Cl. 705/500

(57) ABSTRACT

A method for building consumer loyalty and aiding specific identification of consumer products is disclosed. A first consumer product having a first product label thereon and marketed under a brand includes a removable first identifier to be used during subsequent shopping for readily and uniquely re-identifying the particular product for which it is intended. The first identifier includes shrunk versions of selected indicia from the product label in a not-to-scale manner, selected indicia being shrunk to different degrees such that critical identifying indicia on the first identifier is easily readable and comparable to the first product label. The product container can include a second identifier for a second consumer product distinct from the first consumer product. If the first product label is revised to a second product label, the second product label can include an image of the first identifier for comparison by the consumer.

### CROSS-REFERENCE TO RELATED APPLICATIONS

This application is a continuation-in-part of U.S. patent application Ser. No. 12/220,519 filed Jul. 25, 2008, which is incorporated by reference herein.

### FIELD OF THE INVENTION

This document concerns an invention relating generally to a method and system for building consumer loyalty and aiding specific consumer product identification and re-identification.

### BACKGROUND OF THE INVENTION

The continued efforts of the merchandising industry to simplify consumer product recognition while attempting to obtain brand and product buying loyalties take on numerous forms. Look at the cute Pillsbury Dough Boy®, the little BIC® man, and Elmer's® famous cow upon their glue. In an attempt to maintain or gain a greater share of the market, manufacturers continually introduce new products to suit more specific needs, be more environmentally friendly, or to simplify everyday living. While this constant influx of new and/or improved products is beneficial to consumers, it also increases consumer confusion and frustration, especially when the consumer has found a particular consumer product having particular desired characteristics (e.g., formulation, source, physical form, preparation, quantity, etc.). Valuable time and energy spent by consumers in an attempt to recall, locate, and identify a specific product increases with the increased variety of products made available to them. This can be exacerbated when a surrogate shopper who is less familiar with the product desired by another consumer is attempting to locate the particular product among all the options available at a store.

Product manufacturers are not alone in this struggle to simplify specific product identification and consumer purchasing. Retailers also search for a solution to this endeavor. Self-check-out systems have been placed in stores to speed up or simplify the consumer check out process. A nationwide grocery chain is working on a concept that would offer a consumer the ability to scan and bag desired purchases upon removal from shelves. Menards® stores have implemented a method to simplify and increase the efficiency of merchandise returns. Many merchandise returns result from consumer inability to remember or recognize specific products sought. Another concept was recently televised where a consumer could utilize an electronic device attached to a shopping cart. This device is intended to aid the consumer in the ability to locate products within a retail establishment. The demand to obtain consumer loyalties, accommodate consumer needs, and simplify specific product recognition and consumer purchasing is great.

U.S. Pat. No. 6,113,148 to Koranda (2000) discloses a shopping reminder system that comprises a removable, self adhesive, indicator element as a miniature image of the product label to which it is attached. The simplicity of Koranda's invention is attractive. However, this simplicity causes the invention to fall short of the ability to accommodate the vast and various needs of product manufacturers. The need for invention design flexibility and numerous features capable to accommodate the multitude and variety of available products, the variations incurred with product size and methods of packaging, the wide array of similar products within a line, has not been fulfilled to the extent necessary to accommodate producers' needs. A simple test that illustrates some of the inefficiencies within U.S. Pat. No. 6,113,148 can be accomplished by viewing a product advertisement found in a newspaper. The need to be clear, concise and inclusive of all information for future and specific product re-identification, while maintaining an attachment relatively small in size, is lost.

U.S. Pat. No. 6,898,881 to Morrison (2005) discloses a removable product quantity indicator tab with reusable adhesive qualities. The scope of the Morrison invention is narrow. It is a discrete shopping reminder system that relates to products where usage or depletion levels are visually hidden from the consumer. More specifically, the Morrison invention applies to web wound products or containers that hold a multitude of the same product such as a box of facial tissue. This indicator tab is intended to warn a consumer of a product that nears total depletion and the need, if desired, to replenish the product. The narrow scope of the Morrison patent, along with the design features offered, continues to lack in the versatility and options required for a consumer product identification system with the ability to accommodate the differentiating needs of product manufactures.

U.S. Pat. No. 7,195,689 to Adams, et al. (2007), relates to the manufacture and use of double-sided labels that include printed information on their front and back sides. More specifically, labels attached to a product in a permanent manner with design attributes that enable a portion of the label to be detached for consumer usage. Although U.S. Pat. No. 7,195,689 stakes claim to methods of consumer use, none of the methods stated address that of a “Consumer Product Recognition System”.

None of the above inventions and patents taken either singly or in combination are seen to describe the present invention as claimed.

### SUMMARY OF THE INVENTION

The current disclosure addresses a resolution to consumer confusion and frustration while providing product manufacturers a new venue in which to obtain and maintain consumers' product buying loyalties. It also simplifies consumer purchasing at the retail level.

This is accomplished through the creation of label-type stickers or an easily detachable section of a product's current label or its packaging. For the purposes of this invention these creations will be referred to as “product identifiers” or simply an “identifier”. Product identifiers comprise concise information in a compact form having multiple layers of indicia and information useful to the consumer. A product identifier would not only be capable to hold information for future product recognition purposes, but capable to sell product benefits. Approximately the size of a large United States postage stamp, it has the ability to take on unique or novel shapes. Designed to be easily removed, or detached from a product or its packaging, a product identifier has the ability to be posted on a shopping list, refrigerator door, computer screen, or other such receptacle.

From the brief and general descriptions above a number of objectives and advantages become evident.

The object to provide a specific product identifying system that does not require special talent or a special device to use has been met.

Instant and immediate consumer acceptance, usage, and gratification are of great advantage.

It is an advantage to have invention options and allowances made for easy removal of a consumer product identifier, along with informational instructions to do so.

It is another advantage to use one “future” product identifier (i.e., an identifier for re-identifying a specific product in the future) numerous times.

Consumer usage of a product identifier offers an inexpensive method to reinforce and ensure consumer product loyalty.

It is inevitable that these product identifiers will be posted in locations such as the home, office, work place, or car. This results in product and brand advertising at no additional cost to the manufacturer.

A consumer's repetitive handling and use of a product identifier will inevitably draw interest to other products within that brand, which illustrates yet another advantage to product manufacturers.

The current disclosure decreases consumer time spent shopping for desired or necessary purchases and therefore increases the amount of leisure shop time. This results in additional product sales, a benefit at both the manufacturing and retail levels.

Decreasing consumer confusion and frustration results in a decreased need of customer service employees.

The object to decrease merchandise returns due to incorrect purchases is another advantage obtained.

A product identifier designed with the inclusion of a machine-readable product code such as a Universal Product Code, or a bar code, can be removed from large and cumbersome products for scanning purposes, which accomplishes the objective to simplify the purchase and check out process of such items.

It is advantageous to provide flexible design attributes, which have several layers of meaning to the consumer, to reinforce both brand and product loyalty. The object to enable the inclusion of, for example, safety precautions or allergy warnings, school support programs, recipes, and sale enticements such as redeemable manufacturer coupons, game tokens, or web site addresses within a product identifier has been met through various design options offered.

It is yet another advantage to have the option to reinforce product recognition through an embodiment that has the ability to take on various product or product related shapes.

The flexibility of a product identifier to be either transparent or opaque is highly desired to accommodate the varying needs of product manufactures.

The object to offer an embodiment capable of functioning in a dual manner, a product label and a future consumer product identifier, has been met and made available.

The combination of the transparent feature with that of the dual purpose option stated above is especially beneficial for those products small in size. To present a simple example (not illustrated in the drawings), a common disposable ink pen has an approximate circumference of one inch (approximately 2 ½ cm). This offers adequate area to place a future product identifier upon it. The transparent feature allows a consumer to view both the level and color of ink remaining.

For those manufacturers that prefer, or for products better suited to, the option of a product identifier being a portion of a product's already existing main product label has been made available.

A product and brand loyalty system with capabilities to be designed in a fold out or accordion manner that utilizes limited space is advantageous. Also considered with regard, is the product's pre-existing area located directly behind the placement of a product identifier. This pre-existing area is available for numerous uses. One such use may be that of a manufacturer's desire to show gratification for consumer loyalty.

The ability to reach foreign language speaking consumer sectors through the inclusion of a secondary language(s) upon an embodiment is another objective met.

Another benefit derived from the current disclosure is a product purchasing system that simplifies and aids those who attempt to shop for others.

Enticing consumers into retail establishments is an ongoing goal for manufacturers and retailers alike. This physical presence often results in additional sales not otherwise obtained. More difficult to achieve are the sales and revenues gained through those truly disabled and homebound consumer sectors. While the current disclosure simplifies the purchasing process for those friends and family members willing to assist the disabled and homebound, an option is also available for those retailers interested to offer further assistance with this sector of our consumer population. Up until now the ability to easily compile a complete, accurate, and a detailed shopping list to fax, send, or deliver to a retail establishment for fulfillment of one's needs has been nonexistent or clumsy at best. This can now be accomplished in a convenient and efficient manner.

For numerous reasons the usage of Braille in the merchandising industry is uncommon. The current disclosure offers the use of Braille to accommodate the vision impaired. Whether or not a product manufacturer utilizes the Braille option, those consumers with vision impairments will come to understand consumer product identifiers along with their intent and the benefits derived from them.

It is desirable to have “A Consumer Product Recognition System” that has all the benefits without the drawbacks of the related art.

Although the descriptions above contain many specifics, these should not be construed as limits to the scope of an embodiment, but merely to provide illustrations of some of the presently preferred embodiments.

These advantages and other objects of the present invention will become more readily apparent upon further review of the following specification and drawings.

### BRIEF DESCRIPTION OF THE DRAWINGS

A complete understanding of the present invention may be obtained by reference to the accompanying drawings, when considered in conjunction with the subsequent descriptions in which:

In the drawings, related figures have the same number but different alphabetic suffixes.

FIG. 1A is a perspective front view of a product identifier that illustrates the ability of an embodiment to take on that of a unique or novel shape; in this illustration the shape is that of a product's container: a pill bottle.

FIG. 1B is a perspective back view of the product identifier displayed in FIG. 1A.

FIG. 1C is an environmental front view of the corresponding consumer product displaying the placement of the product identifier illustrated in FIGS. 1A & B.

FIG. 1D is a duplicate environmental front view of the consumer product displayed in FIG. 1C prior to the placement of the product identifier illustrated in FIGS. 1A & B in accordance with one embodiment.

FIG. 2A is a perspective front view of a product identifier that was previously a portion of an already existing primary or main product label.

FIG. 2B is an environmental front view of the corresponding consumer product that illustrates the product identifier displayed in FIG. 2A as a perforated portion of the product's already existing primary product label in accordance with another embodiment.

FIG. 3A is a perspective front view of yet another embodiment designed with an extended or protruding tab like feature for additional simplicity and ease of removal.

FIG. 3B is a perspective back view of the embodiment displayed in FIG. 3A and illustrates the option of placing additional indicia and information upon an identifier's back side prior to the application of adhesive. In this illustration, the back side of the identifier includes indicia in a second language.

FIG. 3C is an environmental front view of the corresponding consumer product displaying the placement of the product identifier illustrated in FIGS. 3A & B.

FIG. 3D is a perspective front view of a product identifier illustrating the ability of an embodiment to take on the actual shape of its corresponding product; in this illustration the shape is that of an adhesive bandage.

FIG. 3E is a perspective back view of the embodiment displayed in FIG. 3D illustrating the option of placing additional indicia and information upon an identifier's back side prior to the application of adhesive.

FIG. 3F is an environmental front view of the corresponding consumer product that displays the placement of the uniquely shaped product identifier illustrated in FIGS. 3D & E.

FIG. 4A is a perspective front view of a partially transparent product identifier designed to perform as a dual purpose embodiment, that of a product's primary label along with the ability to be a detachable product identifier.

FIG. 4B is an environmental front view of the corresponding consumer product that displays the placement of the product identifier illustrated in FIG. 4A such that the product identifier also serves as the product's primary label in accordance with another embodiment.

FIG. 5A is a plan view of a further embodiment designed in a fold out manner offering additional area for the placement of indicia and information upon a product's identifier.

FIG. 5B is a perspective front view of a fold out style product identifier (as illustrated in FIG. 5A) in its “fully closed” configuration.

FIG. 5C is a perspective view of the mid or inner panels created for the product identifier displayed in FIG. 5B. FIG. 5C illustrates FIG. 5B in a “fully open” configuration.

FIG. 5D is a perspective view of the outer panels or the surface of the back- and front-most panels created for the product identifier shown in FIG. 5B. FIG. 5D illustrates FIG. 5B in a fully open configuration.

FIG. 5E is an environmental front view of the corresponding consumer product for the identifier displayed in FIGS. 5B, C & D.

FIG. 5F is an environmental back view of the corresponding consumer product (FIG. 5E) and displays the placement of the product identifier illustrated in FIGS. 5B, C & D.

FIG. 5G is a plan view of a yet another fold out product identifier illustrating the ability of a multi panel embodiment to take on a product use related shape, in this illustration the shape corresponds to that of a house fly.

FIG. 5H is a perspective front view of the uniquely shaped fold out product identifier (as illustrated in FIG. 5G) in its fully closed configuration.

FIG. 5I is a perspective view of the inner panels of the product identifier displayed in FIG. 5H. FIG. 5I illustrates FIG. 5H in a fully open configuration.

FIG. 5J is a perspective view of the outer panels or the surface of the back- and front-most panels of the product identifier shown in FIG. 5H. FIG. 5J illustrates FIG. 5H in a fully open configuration.

FIG. 5K is an environmental front view of the corresponding consumer product for the uniquely shaped identifier displayed in FIGS. 5H, I & J.

FIG. 5L is an environmental back view of the corresponding consumer product (FIG. 5K) and displays the placement of the uniquely shaped product identifier illustrated in FIGS. 5H, I & J.

FIG. 6A is a plan view of yet another example embodiment having that of an accordion or plurality fold out design offering additional area for the placement of indicia. This example embodiment illustrates the ability to place indicia and information upon all six panels created while maintaining a product identifier relatively small in size.

FIG. 6B is a perspective front view of an accordion style product identifier (as illustrated in FIG. 6A) in its fully closed configuration.

FIG. 6C is a perspective view of the front and mid sectional panels of the product identifier displayed in FIG. 6B and illustrates the product identifier in its fully open and extended position.

FIG. 6D is a perspective view of the back and mid sectional panels of the product identifier displayed in FIG. 6B displaying the product identifier in a fully open and extended position while illustrating the placement of indicia upon two of the three panels available for communication.

FIG. 6E is an environmental front view of the corresponding consumer product and displays the placement of the product identifier illustrated in FIGS. 6B, C, D & G.

FIG. 6F is a duplicate environmental front view of the consumer product (displayed in FIG. 6E) and illustrates the use of a novel sticker for maintaining the multi panel identifier (illustrated in FIGS. 6B, C, D & G) in a closed position.

FIG. 6G shows alternative back and mid sectional panels of the product identifier displayed in FIG. 6B while illustrating the placement of indicia upon all three panels available for communication.

FIG. 7A is a perspective front view of an embodiment illustrating a product identifier taking on a novel shape; the upper portion of the product identifier takes on the shape of a corresponding consumer product logo or other trademark.

FIG. 7B is a perspective back view of the embodiment displayed in FIG. 7A and illustrates the option of placing additional indicia such as a consumer enticement upon a product identifier's back side prior to the application of adhesive.

FIG. 7C is a perspective front view of a product identifier that illustrates the ability of an embodiment at least in part to take on the shape of a corresponding consumer product's trademark; the embodiment illustrated is not for re-identification of the consumer product (FIG. 7E) it is posted upon, but to entice the sale of a different product within the producer's line by providing another identifier corresponding to the different product.

FIG. 7D is a perspective back view of the product identifier displayed in FIG. 7C and illustrates the option of placing additional indicia such as a slogan upon an embodiment's back surface prior to the application of adhesive.

FIG. 7E is an environmental front view of the corresponding consumer product displaying the placement of the product identifiers illustrated in FIGS. 7A, B, C and D.

FIG. 7F is a near actual size environmental front view of the consumer product illustrated in FIG. 7E following a change from the first main product label of FIG. 7E to a newly-designed second main product label.

FIG. 7G is a perspective front view of a product identifier corresponding to the second main product label for the consumer product illustrated in FIG. 7F, and illustrating the ability of an identifier to take on two or more product related shapes; in this example the image of an orange slice is ghosted behind other product identifying indicia. The second main product label includes an at least substantially duplicated image of the identifier of FIG. 7A, which corresponds to the first main product label.

FIG. 7H is a perspective back view of the product identifier displayed in FIG. 7G and illustrates the placement of indicia upon the embodiment's back side prior to the application of adhesive. In this illustration the indicia invites consumers to visit the producer's web site.

FIG. 8A is a near actual size environmental front view of a product container with two of the product identifiers illustrated in FIGS. 8B & C.

FIG. 8B is a perspective front view of a product identifier that illustrates the ability of an embodiment to take on that of a unique or novel shape.

FIG. 8C is a perspective back view of the embodiment displayed in FIG. 8B and illustrates the option of placing additional indicia upon an identifier's back side prior to the application of adhesive.

With the exception of the simulated consumer product drawings, all other drawings are illustrated in functional scale and size ranges. The figures that illustrate single panel embodiments, or embodiments in their fully folded and compact position, range in size from approximately 1 & ¼ to 2 inches (3 to 5 cm) wide by approximately 1 to 1 & ¾ inches (2 ½ to 4 ½ cm) high. There are no restrictions or specific guidelines to the size of an actual embodiment. However, to view these example embodiments in this manner better illustrates the ability to present key product identifying information in addition to a wide array of supplemental enclosures in a clear and concise manner within a relatively small area. This area is receptive to additional size reduction while continuing to maintain clear and concise properties. The introduction of color enhances an embodiment, which contributes to additional clarity. Other plan and section views of the embodiments, considerable mechanical detail of devices for the production of labels, and the application of print and adhesive have been omitted. Such details are not considered necessary for one skilled in the art to obtain a full and complete understanding of the invention disclosed herein. It should also be understood that the present invention is not limited to the embodiments illustrated.

### Drawings: Reference Numerals

The present invention is of a type that incorporates the use of a detailed method and system with that of a specially designed product detachment. Therefore, a listing of the various components along with a definition or description of their intent and/or methods of use follows to create additional ease to understand the current disclosure. No limitations should be understood therefrom, as modifications will be obvious to one skilled in the art.

In the drawings, reference is made to accompanying drawings wherein like components have like reference numerals and components similar in nature have like reference numerals but different alphabetic suffixes.

Reference Numeral 10 (10a, 10b, 10c, 10d, 10e, 10f 10g, 10h, 10i, 10j, 10k, and 10m) indicates an example placement location of an embodiment upon a simulated consumer product's primary label or packaging. Due to individual manufacturer preferences, along with differentiating product needs, the current disclosure offers no specific guidelines for the placement of a product identifier upon its corresponding product. Numerous situations arise that require placement flexibility. Many products on our market today are sold in packaging that is removed and discarded prior to actual product usage. For those identifiers placed in low or non-visible locations during the product marketing or pre-consumer purchase stages, it is suggested that considerations be made to inform consumers in another manner of the inclusion of a product identifier. The incorporation of a simple statement on the front of the primary product label or its packaging that notify consumers of the hidden enclosure would be of significant value until which time these identifiers come to be expected.

Reference Numeral 11 (11a, 11b, and 11c) refers to an area in which an adhesive substance has been applied to an embodiment. In most cases illustrated, this adhesive application is intended to serve that of a dual purpose. It is intended to affix a product identifier to its corresponding product's primary label or packaging and offer reusable qualities to the consumer. That being the case, a non-drying, quick release type of adhesive that allows both non-damaging removal of an embodiment along with qualities that enable the consumer to re-apply an identifier numerous times would be best selected. For consumer products that require refrigeration, frozen goods, or products that are exposed or stored in a humid environment, adhesives that have the additional quality of moisture resistance need to be considered. A complete adhesive backing is not required. The option to place adhesive upon four corners (illustrated in drawings) or in the shape of an “X” (not illustrated) would suffice. There are numerous types of adhesive and methods of application in addition to numerous methods in which to include or affix a product identifier to that of a consumer product. None are intended to be eliminated or discouraged. Even a product identifier without adhesive qualities would be better than no identifier at all.

Reference Numeral 12 (12a, 12b, 12c, 12d, and 12e) illustrates embodiment removal and use instructions or the instructive insignia, “Peel N Post”. These instructions, illustrated in several different manners, are important as an aid to create consumer awareness of the inclusion of a future product identifier along with encouraging its use.

Reference Numeral 13 (13a and 13b) illustrates the option of placing a product's trademark, logo, or related image in the form of a water mark or a faded (ghost like) image as a background to, or behind, other communicating information. This option was created as an aid to maintain an embodiment relatively small in size.

Reference Numeral 14 (14a, 14b, 14c, 14d, 14e, 14f, 14g, 14h, 14i, 14j, 14k and 14m) refers to key product related or identifying information. The desired goal in this area is to select (from the product's main label) and present enough key product information in a clear and concise manner to enable a consumer to easily recognize, at a future point in time, the specific product for which the identifier was intended.

Reference Numeral 15 (15a and 15b) refers to the inclusion and placement of a machine-readable product code upon an embodiment. In most illustrations, allowances have been made in the drawings for the inclusion of a Universal Product Bar Code. The display of an embodiment in this manner is not intended to exclude the use or inclusion of other current or future machine-readable product codes. A Universal Product Bar Code is commonly displayed upon a white back ground and has a 1 to 1 & ½ inch (2 & ½ to 4 cm) width requirement that must be considered when incorporated into a product identifier. The height is flexible and can be altered or changed with no appreciative loss of function. This height flexibility is an advantage to maintain a product identifier relatively small in size. Not required for the success of the current disclosure, there are many advantages to be gained through the inclusion of a machine-readable product code upon a future product identifier.

Reference Numeral 16 indicates the avoidance of adhesive in an area to simplify embodiment removal. In most illustrations this area is located directly behind the “Peel N Post” instructive insignia (Reference Numeral 12). There are many methods in which to remove or simplify the removal of a product identifier from the product to which it corresponds. The avoidance of adhesive illustrates only one such method to do so.

Reference Numeral 17 (17a, 17b, 17c, 17d and 17e) illustrates the inclusion of a product logo or trademark upon an embodiment. Manufacturers and consumers strongly associate a product logo or trademark with that of a specific product, product line or brand. Such an inclusion not only aids the majority of the consumer populations, but is an even greater benefit to the foreign and illiterate consumer sectors.

Reference Numeral 18 (18a, 18b, 18c, 18d, 18e, 18f 18g and 18h) illustrates the inclusion of the product name and/or brand upon an embodiment. Font style, color, and method of display seen upon a product's primary label or packaging would be best replicated when placed upon the product's future identifier.

Reference Numeral 19 (19a, 19b, 19c, 19d, 19e, 19f 19g and 19h) refers to a product related image or use related image incorporated into an embodiment as a visual aid for future product identification purposes. Once again, one can see the benefits such an inclusion offers not only to the majority of the consumer populations but also the foreign and illiterate sectors.

Reference Numeral 20 (20a and 20b) illustrates the option to place an informational statement or message to the consumer that notifies them of an additional enclosure(s) within or upon the reverse side of an embodiment.

Reference Numeral 21 (21a, 21b, 21c, 21d, 21e, 21f 21g and 21h) displays the option and ability to incorporate consumer enticements within an embodiment. By illustrating the inclusion of enticements in this manner, it is not intended to limit or restrict the type or form of enticement included or the need to utilize this area for that of an enticement.

Reference Numeral 22 illustrates the ability to reinforce or include product warnings or precautions within an embodiment. These warnings may take on many forms; contains shell fish, latex, small parts not recommended for ages three and younger, and fatal if ingested state just a few. Again, by illustrating an area within an embodiment for a suggested use, the intent is not to limit the use or type of enclosure placed within an embodiment.

Reference Numeral 23 indicates the location of a fold(s) within the multi panel embodiments illustrated. It is at a fold location that the addition of perforation (not illustrated) may be considered. The addition of perforation to an embodiment with more than one panel offers consumers the ability to detach, in a non-damaging manner, and use or discard those sections of an embodiment that are or are not of interest to them. This simplifies a somewhat complicated embodiment. There are numerous methods other than those illustrated in the current disclosure, in which to fold, reduce, or keep an embodiment relatively simple and small in size. None are intended to be eliminated or discouraged.

Reference Numeral 24 refers to the option of using perforation to simplify the removal of an embodiment that has been created as a portion of a product's already-existing main label.

Reference Numeral 25 (25a and 25b) indicates temporary closure methods for maintaining a bi or multi panel embodiment in its fully closed and compact position until which time a consumer would like to view the embodiment in its entirety. The examples of an adhesive application and that of an additional novel sticker are only two methods in which to maintain the temporary closure of an embodiment; a producer may prefer a plastic overlay to serve this purpose. Numerous methods are available, none are intended to be eliminated or discouraged.

### Detailed Description of Preferred Versions of the Invention

The material composite of a future product identifier is largely determined by the type of consumer product the identifier is being placed upon, the pre-existing primary product label or the packaging it is being incorporated into, or one's preference. In circumstances where it is undesirable for a product or its contents to be obscured or located behind its future product identifier, a composite that creates a thin, flexible, and transparent embodiment may be used. It is assumed that an identifier placed upon a product intended for human or animal consumption is of a material composite safe for such. It is also recommended that considerations be made that upon consumer removal and repeated use of a product identifier a material composite that discourages distortion or damaged is used. Respecting the value of a product's current primary label space and the desire to place an identifier upon a consumer shopping list or some such transportable carry along instrument encourages an identifier of relatively small proportions. Therefore, an effort to present product identifying indicia and information in an all inclusive, yet condensed, method which maintains clear and concise properties is strongly recommended. The current disclosure offers numerous options and illustrations that enable obtainment of that goal in a simple and efficient manner.

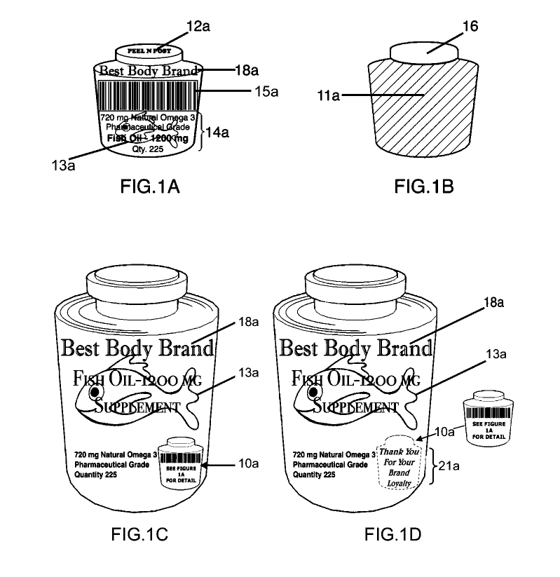

FIGS. 1A, B, C and D

Referring now to FIG. 1A, the product identifier illustrated is in the shape of the product to which it is associated, a pill bottle (FIGS. 1C and 1D). Thus, displaying the option of a product identifier to take on unique or product related shapes. An identifier placed upon a box of canine treats may take on the shape of a bone (not shown), and so on. The removal and use instructions, or the instructive insignia 12a, “Peel N Post”, can be seen placed within the cap portion of the pill bottle-shaped identifier or at the top of the identifier. Best Body Brand 18a, the simulated product name, follows and would be best displayed in a manner identical to that shown upon its corresponding consumer product (FIGS. 1C and 1D). Note the inclusion of a machine readable product code 15a. Key product identifying information 14a is intended to offer a consumer very exact and specific product identifying information. Thus creating future consumer ability to easily recognize, and select for repurchase, the specific product for which the identifier is intended. In order to maintain a product identifier that is clear, concise, and relatively small in size, there will be a need to exercise caution to ensure selecting a sufficient amount of specific product identifying information, yet not become too obtrusive. In FIG. 1A, an identifier for that of a dietary supplement, the key product identifying information 14a appears as follows. The type of supplement is of importance, “Fish Oil”. “1200 mg” tablets along with the information that “720 mg (are) Natural Omega 3” further identifies the specific product. The inclusion of the statement “Pharmaceutical Grade” also aids in future product identification along with presenting information that may be viewed as a sales enticement. The optional inclusion of a product's quantity, “Qty. 225” illustrated, is controversial and affected by numerous factors. Should a product be of the type that offers a variety of different quantity options available for purchase, one may wish to state the various options available such as: Qty. 50, 100, or 150 pieces or 100, 150, or 200 fluid ounces (2.95, 4.44, or 5.91 liters), and so on. A product manufacturer may prefer the sale of one quantity over that of another for reasons such as packaging costs or profits to be made. Consumers have a variety of reasons for selecting specific quantities: storage space, cost, or the desire to avoid product waste, name only a few such reasons. Therefore, the inclusion upon a future product identifier of a product's quantity, or quantity options available for purchase, the benefits, drawbacks, or the manner in which this is done, is available for additional consideration by one skilled in the art. The faded or ghost like image 13a of the fish, which is intended to portray that of a product-related image, is located and can be viewed behind the key product identifying information 14a. The ability to place a logo, trademark or product-related image in this fashion aids in maintaining a product identifier relatively small in size while offering an additional aid to the consumer for future product identification purposes. When viewing FIG. 1A in its entirety, with the exception of the instructive insignia 12a, all of the indicia (indicia, intended to encompass all printed matter) in addition to the actual shape of the identifier presented, direct one toward future and specific product re-identification. The inclusion and replication upon an identifier of its corresponding product's color scheme (not shown) tremendously enhance the product identifier, which contributes additional effectiveness to its intended use.

FIG. 1B illustrates the perspective back view of the product identifier displayed in FIG. 1A. A non-drying quick release type of adhesive application 11a performs that of a dual purpose, attachment of the identifier to its corresponding consumer product container (FIGS. 1C and 1D) along with offering reusable qualities to the consumer. The exclusion of adhesive 16, located directly behind the “Peel N Post” instructive insignia (12a seen illustrated in FIG. 1A) simplifies consumer removal of the product identifier from its corresponding consumer product (FIG. 1D).

FIG. 1C illustrates the corresponding consumer product to that of the identifier displayed in FIGS. 1A & B. It is not the intent of the inventors to imply or request a product's first or pre-existing label be altered to duplicate the appearance of its future product identifier. Therefore, when noting the faded or ghost like image 13a presentation similarities displayed upon the consumer products in FIGS. 1C and 1D, and that of the product identifier displayed in FIG. 1A, this similar method of presentation has been done for the purpose to offer additional clarification in the use of such method. An area where it is important to consider exact duplication, the product name, “Best Body Brand” 18a has been duplicated in font and manner of display when placed upon its product identifier (FIG. 1A). The placement 10a of the product identifier (illustrated in FIGS. 1A & B) upon its corresponding consumer product (FIGS. 1C and 1D) can be seen located on the front and lower right-hand corner. Actual placement of a product identifier upon its corresponding consumer product is extremely flexible. In many situations an identifier may fit into that area currently set aside for a product's machine-readable code. This requires little or no need to alter or change a product's current primary label or its packaging for the inclusion of a future product identifier.

FIG. 1D is a duplicate image of FIG. 1C illustrating the corresponding consumer product to that of the identifier displayed in FIGS. 1A & B prior to the placement of its future product identifier (FIGS. 1A and 1B). This illustration shows the option of a producer utilizing the area located directly behind a product identifier to place a token of appreciation statement 21a: “Thank You For Your Brand Loyalty”.

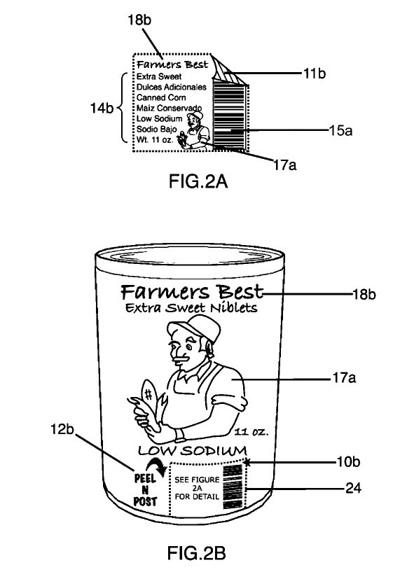

FIGS. 2A & B

The following description, combined with its corresponding drawings, illustrates the option to incorporate an embodiment into an already pre-existing product label. Referring first to FIG. 2B, intended to simulate a common consumer product and its already existing product label, the embodiment can be seen placed at 10b and incorporated into the front and lower portion of the product's main label. The use of perforation 24 as an option to simplify the removal of an embodiment incorporated in this manner is also illustrated. The flexibility to place the instructive insignia 12b in a location other than upon the actual embodiment is illustrated adjacent to its future product identifier displayed in FIG. 2B. “Farmers Best” 18b, intended to be that of the product name, can be seen presented in identical font and manner upon its corresponding product identifier illustrated in FIG. 2A as that displayed upon the consumer product in FIG. 2B. The farmer pictured in both FIGS. 2A & B is intended to illustrate the product's trademark 17a.

Referring now to FIG. 2A, a perspective front view of the future product identifier that corresponds to the consumer product illustrated in FIG. 2B. Illustrated here is an adhesive 11b option that would require a consumer to moisten the adhesive for the purpose to attach an identifier to a secondary surface. The inclusion of a machine readable product code 15a can be seen placed in a vertical position along the identifier's right-hand side. The key product identifying information 14b is illustrated in both the English and Spanish language. The use of two languages illustrates the ability to include a larger sector of the consumer market. By submitting the current disclosure in the English language and selecting the Spanish language to illustrate the inclusion of a secondary language, the intent is not to promote or show bias to any one language over that of another. The product name, “Farmers Best” 18b has not been converted or illustrated in a secondary language. Product brands and product names are often a language of their own, should there be a desire for translation, the option is available for one to do so. The additional key product identifying information 14b states that this specific product is the manufacturer's “extra sweet” variety of canned (not frozen) corn in the 11 ounce size and is lower in sodium then other versions of the product line available. The inclusion of information such as low sodium, cholesterol free, or contains shell fish upon a product's future identifier illustrates the ability to offer additional aid to those consumers that have medical conditions that need to be considered.

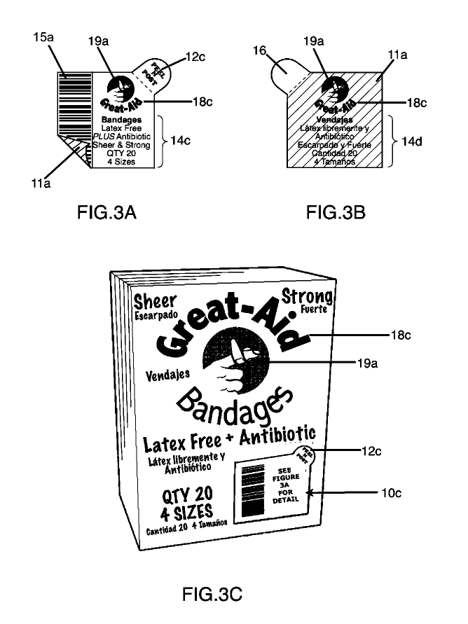

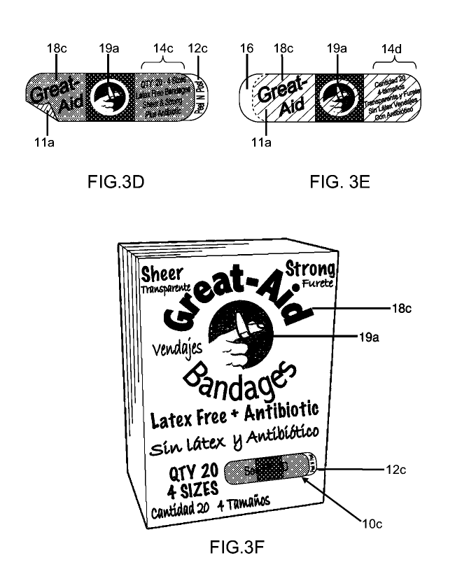

FIGS. 3A through 3F

FIGS. 3A & B display yet another embodiment that illustrates additional features available for incorporation into a future product identifier. FIGS. 3A & B display an identifier that has been designed with an extended tab feature that creates additional ease in the removal of an identifier. It is upon this extended tab that the instructive insignia 12c, “Peel N Post”, has been placed (FIG. 3A & C). The exclusion of adhesive 16, for even additional simplicity to remove an identifier from its corresponding consumer product (FIG. 3C), can be noted behind this tab like feature in FIG. 3B. Also illustrated in FIG. 3B is the option of placing additional indicia or information upon an identifier's back surface prior to the application of adhesive 11a. The key product identifying information (14c displayed in FIG. 3A) has been translated into that of a secondary language (14d) and placed upon the identifier's back surface (FIG. 3B) which accompanies the product name 18c, and the product related image 19a. This is only one example of many options available for the use of this area upon the back surface of a product identifier. Another usage example for this area may be the desire to promote other available or new products such as: “Try our new non-stick sterile wraps for larger injuries” (not shown). To avoid creating consumer confusion, or take away from the future product identifier's original purpose, caution is recommended to promote a product other than the one for which the identifier was intended. The key product identifying information 14c (FIG. 3A) informs the consumer that this specific product contains twenty (quantity) sheer and strong (physical description), latex free (allergy information), bandages (product type) in four different sizes (product size) with the added bonus of an antibiotic (consumer benefit or enticement). The picture of a bandage being applied to a finger (FIGS. 3A, B & C) illustrates the incorporation of a product use related image 19a into an identifier as a visual aid to further assist and simplify the product re-identification process. The identifier displayed in FIGS. 3A & B, and illustrated in placement 10c upon its corresponding consumer product in FIG. 3C, is basically in the shape of a square. An identifier in the shape of a bandage (see FIGS. 3D, 3E, 3F, which correspond with FIGS. 3A, 3B, 3C, respectively) would be attractive and offer even further assistance in future product identification.

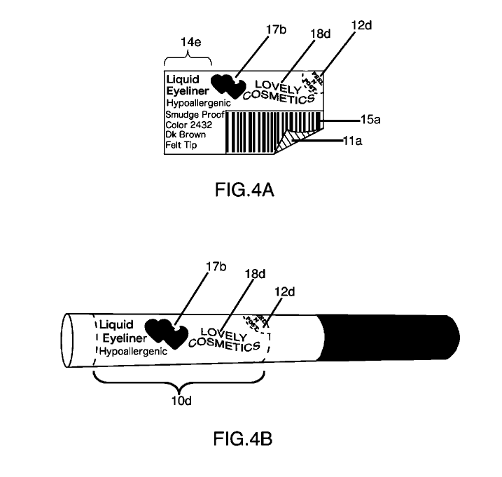

FIGS. 4A & B

There are numerous circumstances that arise where it is desirable to view an actual product, its color, content, or content level within its container or packaging. These situations often require additional label creativity, especially if the product is small in size. FIGS. 4A & B illustrate a partially transparent embodiment capable of functioning in a dual manner, that of a future product identifier (as illustrated in FIG. 4A), and in placement 10d upon its corresponding consumer product (FIG. 4B) essentially comprising the product label. A non-transparent white background is commonly needed if including a Universal Product Bar Code as the product's machine-readable code 15a. Therefore, the bar code in FIG. 4A can be seen placed within a box that is intended to illustrate its placement upon a non transparent area. Continuing to refer to illustration FIG. 4A, accompanying the simulated product name 18d “Lovely Cosmetics” and trademark 17b (the double heart image) is the section that contains the product's key identifying information 14e. In this example embodiment the key product identifying information 14e starts with listing the product's form or type “Liquid Eyeliner” in a somewhat bolder and larger font size than other product identifying information included. Including a product's physical form such as “Liquid”, not solid, reduces the risk of negative consumer product association due to re-identification error. The example product (FIG. 4B) intended for application close to the eye, information such as “Hypoallergenic” and “Smudge Proof” may be deemed as important qualities by many of its users. It is common to see products that offer more than one color available for purchase, display both a general color description; “Dk. Brown”, and a more specific color code; “Color 2432”. The final product identifying information (14e) illustrated upon the product identifier (FIG. 4A) is that of the product's method of application, “Felt Tip”. Many consumer products are offered in more than one application type. Paint products are often sold in either a spray or brush method of application. Hair products are offered in both aerosol and pump type applicators. Some consumers prefer hand soap in bar form, while others prefer a liquid form. Should a product have more than one method of application, specifying the application type upon an identifier should be considered. The instructive insignia 12d (FIGS. 4A & B), “Peel N Post”, informs the consumer that the product label has been designed and attached with a type of adhesive (11a in FIG. 4A) that offers easy removal from the product with abilities to be posted for future product identification purposes.

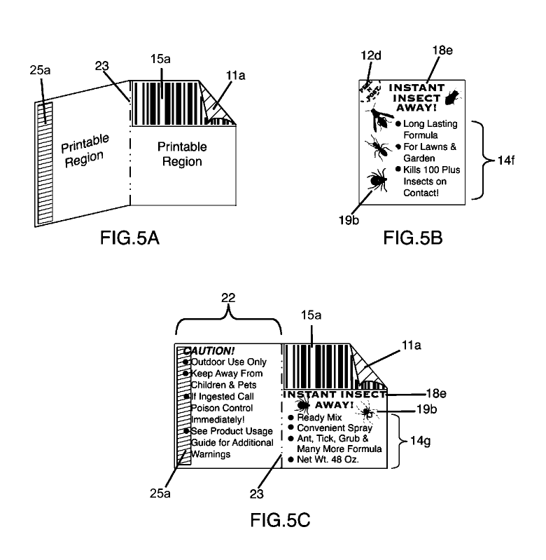

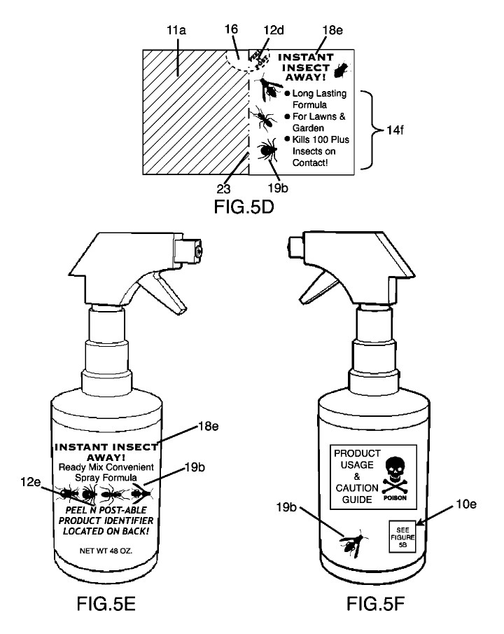

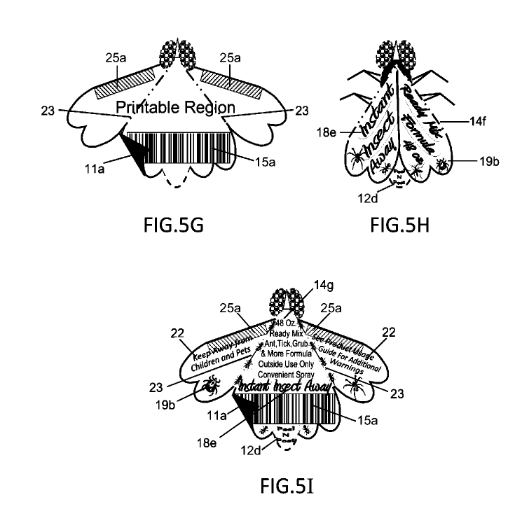

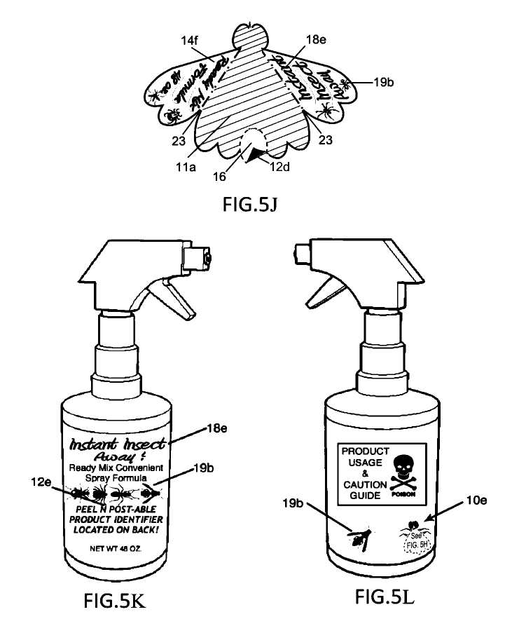

FIGS. 5A through 5L

FIG. 5A illustrates a plan view and FIGS. 5B, C & D illustrate perspective views of an example embodiment for a future product identifier designed in a fold out manner, thus creating additional area for supplemental or product related information. FIGS. 5E & F illustrate environmental front and back views of the example embodiment's corresponding consumer product, an insect exterminator.

In FIGS. 5A,C & D, illustrations that display the example embodiment in its fully open configuration, the fold 23 location can be seen designated. For illustration and description simplification, the example embodiment displayed has been designed in a manner that has created panels simple and equal in size. While this example identifier is attractive and functional, a more creative identifier for this type of product could be designed in the shape of a house fly with wings that fold out (see FIGS. 5G, 5H, 5I, 5J, 5K and 5L which correspond with FIGS. 5A, 5B, 5C, 5D, 5E and SF respectively) exposing product identifying and supplemental information. To refer again to the drawings, FIG. 5B illustrates the face or front perspective view of the product identifier in its fully folded and compact position. This face view is a duplicate to that displayed in the right panel illustrated in FIG. 5D. FIG. 5D displays FIG. 5B in a fully open configuration which illustrates the face panel upon the embodiment's right side and the back surface of the final panel (or the back surface of the right panel seen illustrated in FIG. 5C) upon the left side of the embodiment (in FIG. 5D). FIG. 5C also displays FIG. 5B in a fully open configuration. The identifier's interior panels are illustrated here. Although a product identifier is unique to its corresponding product, numerous options can be seen repeated and incorporated into the design of the example identifiers illustrated throughout the drawings. Therefore, other than to note the following options that have been included into the currently described identifier, any additional detail is deemed repetitive and unnecessary at this time. Once again note in the drawings the adhesive application 11a and a non adhesive area 16, along with the inclusion of the machine-readable code 15a. The product name 18e, “Instant Insect Away” and product related images 19b (insects) have been incorporated into the identifier in numerous locations. The instructive insignia 12d can be seen placed in the upper left hand corner of the identifier's face panel illustrated in both FIGS. 5B & D. Numerous circumstances will place a product's identifier in low or non-visible locations. FIG. 5F displays the current identifier located and placed 10e upon the back side of its corresponding consumer product (FIG. 5F). Therefore, an example to inform consumers of the inclusion of a future product identifier can be seen upon the front of the corresponding product's primary label (12e in FIG. 5E). It is foreseeable that when a product's identifier becomes common consumer knowledge, the need to inform or obtain a consumer's attention in regards to its inclusion may not be necessary. To refer now to the left panel illustrated in FIG. 5C; displayed is the option to reinforce product precautions or warnings 22. Indicia (encompassing printed information) placed in this area is extremely flexible in content. There may be a preference to illustrate product usage or the desire to guarantee product satisfaction, or maybe the inclusion of a secondary language is of importance. For identifiers designed with more than one panel, it is suggested that the panel that bears the re-usable adhesive be the panel holding the key and future product identifying information. By preparing an identifier in this manner, consumers have the option to remove and use or dispose the panels that are or are not of interest to them, this simplifies a somewhat complicated future product identifier. Therefore, it is upon the right panel illustrated in FIG. 5C that all necessary elements needed for a consumer to identify the specific product for repurchase are incorporated. This right panel has the adhesive backing 11a, the product name 18e, use-related image(s) 19b, and the machine readable product code 15a, along with the product's key identifying information 14g. The key product identifying information 14g illustrated informs the consumer that this is the “Ready Mix” version of the product line, not the concentrated, mixing is not required, the method of application follows “Convenient Spray” (not the granule), this specific product within its line is used to extinguish “Ant, Tick, Grub & Many More Formula”, and finally the size is listed “Net Wt. 48 Oz.”. The product information 14f illustrated upon the face panel (in both FIGS. 5B & D) slants toward enticing a consumer while stating the product's effectiveness and areas of use. In the early stages of creating consumer awareness and the intended purpose of a future product identifier, the face panel may be used instead for reinforcing a consumer's usage of the identifier. A simple statement such as; “Need to replenish me? I'm easy to find!” (not shown) encourage a consumer to repurchase the product along with simplifying the future identification process. A final inclusion illustrated in FIGS. 5A & C is that of the option to use a closure adhesive 25a for the purpose to temporarily maintain an identifier in its closed configuration until which time a consumer would like to view the identifier in its entirety.

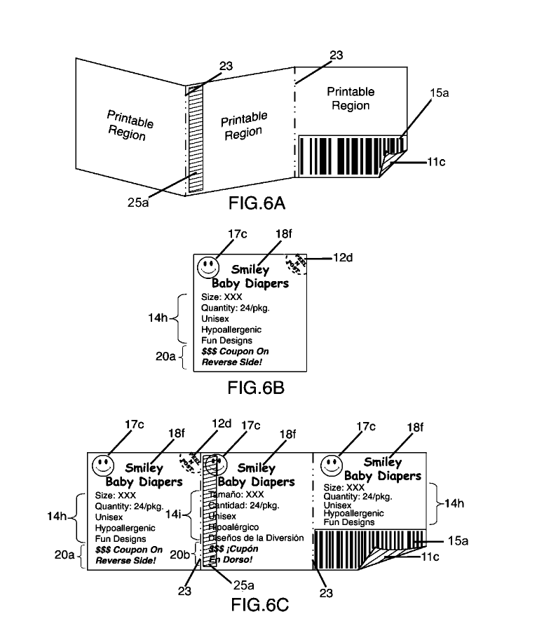

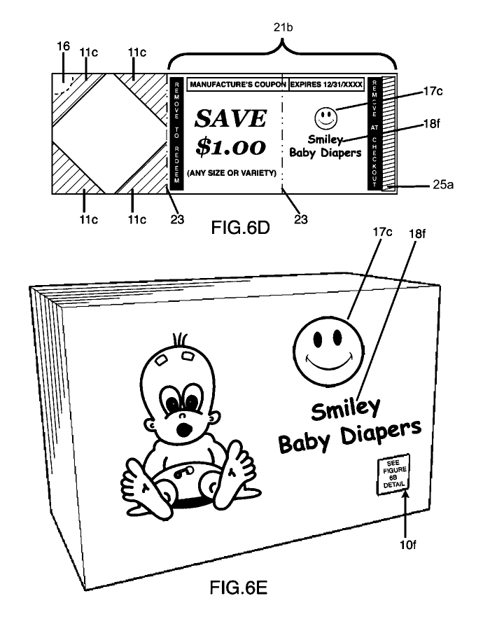

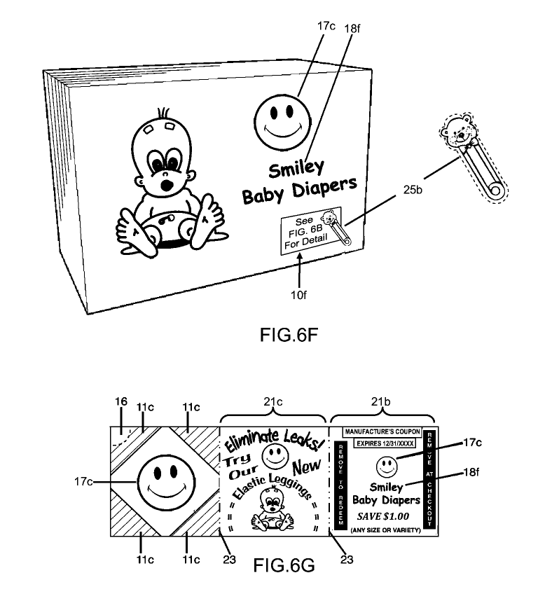

FIGS. 6A through 6G

The ability of a future product identifier to take on numerous forms and serve multiple purposes can be seen illustrated once again in the example embodiment displayed in FIGS. 6A through D and FIG. 6G. FIG. 6A illustrates a plan view, while FIGS. 6B, C, D & G illustrate perspective views, of a simplified accordion or multi panel style embodiment which displays the option to create an identifier with even additional area for indicia. For illustration and description simplicity the example identifier displayed has been designed in a manner which resulted in three equal sized panels. In the following description these panels will be referred to as the left, center or right panel illustrated. The identifier illustrated (intended for baby diapers) is functional and attractive. Should there be a preference for a more creative identifier, one that takes on the appearance and is folded in a manner similar to a diaper (not shown) would be suitable and offer another element for future product recognition. FIGS. 6E and 6F illustrate the environmental front view of the example embodiment's corresponding consumer product, a box of baby diapers. It is upon these illustrations that the identifier's placement 10f can be noted. While the use of an additional adhesive 25a is illustrated in FIGS. 6A, C, and D to maintain a multi panel identifier in a fully closed position, FIG. 6F illustrates the use of a novel sticker 25b to maintain multi panel closure. The novel closure sticker 25b is that of a diaper safety pin with a teddy bear incorporated into the pin's head.

In FIGS. 6A,C & D, illustrations that display the example embodiment in its fully open configuration, the fold 23 locations and closure adhesive 25a can be seen illustrated. FIG. 6B illustrates the face or front perspective view of the product identifier in a fully folded and compact position. It is upon this face panel that the instructive insignia 12d, “Peel N Post” has been placed. This front or face panel, is a duplicate of the left panel illustrated in FIG. 6C. FIG. 6C displays FIG. 6B in a fully open configuration. FIG. 6B is again illustrated in a fully open configuration in FIG. 6D. FIG. 6D displays the back or opposite side of the identifier. It is in this illustration (FIG. 6D) that the options to include a manufacturer's redeemable product coupon 21b, four corners or a partial adhesive application 11c and the non-adhesive area 16 (for removal simplification) are displayed. An enclosure(s) other than a redeemable product coupon may be preferred, the inclusion of Braille, a secondary language(s), or a consumer questionnaire, name only a few such other options available for consideration. The inclusion of the product's machine readable code 15a can be see located in the right panel illustrated in both the plan view, FIG. 6A, and the identifier's perspective view in FIG. 6C. Throughout FIGS. 6B, C & D, and displayed in a manner identical to that upon the primary product label (FIGS. 6E and F, simulated for illustration purposes), the repeated use of the product's trademark 17c, a round smiley face, and product name 18f “Smiley Baby Diapers”, can be noted.

Referring now to FIG. 6C, the face or left panel illustrates the option to inform consumers of an additional enclosure 20a upon the embodiment's reverse side. The enclosure referred to is that of the redeemable product coupon (21b in FIG. 6D) previously discussed. The central panel repeats this informational disclosure 20b in a secondary language. The key product identifying information 14h illustrated in both the left and right panels is identical and repeated again upon the central panel in a secondary language (14i). Note that the necessary elements for future product recognition have been placed upon the right panel, or the panel bearing the patterned re-usable adhesive 11c application. This intentional method of placement allows those consumers not interested in the additional enclosure (21b in FIG. 6D), or in need of a secondary language (the center panel in FIG. 6C), to remove and discard those sections, which reduces and simplifies the future product identifier and its eventual use or placement upon a secondary surface such as a shopping list.

FIG. 6G is an alternative perspective view of FIG. 6D and displays the back and mid sectional panels of the product identifier displayed in FIG. 6B. Like FIG. 6D one can note the patterned re-usable adhesive 11c application, the non-adhesive 16 area for removal simplification and a scaled down in size redeemable manufacture's coupon 21b. Reducing the size of the redeemable coupon created area for the placement of an additional enticement 21c upon the central panel within the future product identifier. The enticement 21c illustrated is for the producer's line of diapers with elastic leggings. The producer's trademark 17c (the round smiley face) has also been added to this alternative view upon the left panel, the panel bearing the adhesive application, as a continued effort to reinforce brand loyalty and product recognition.

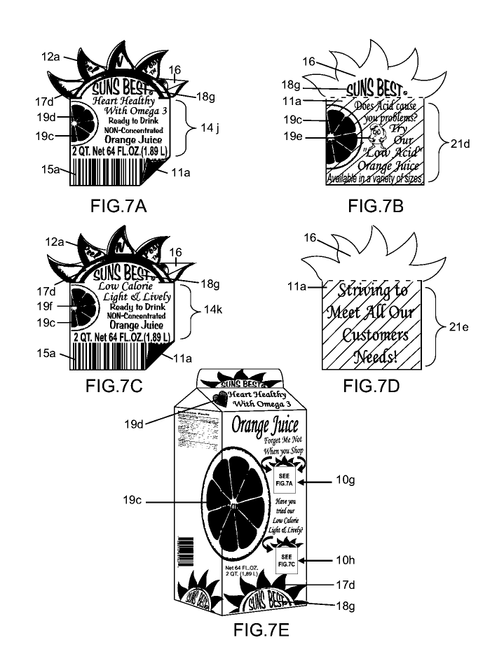

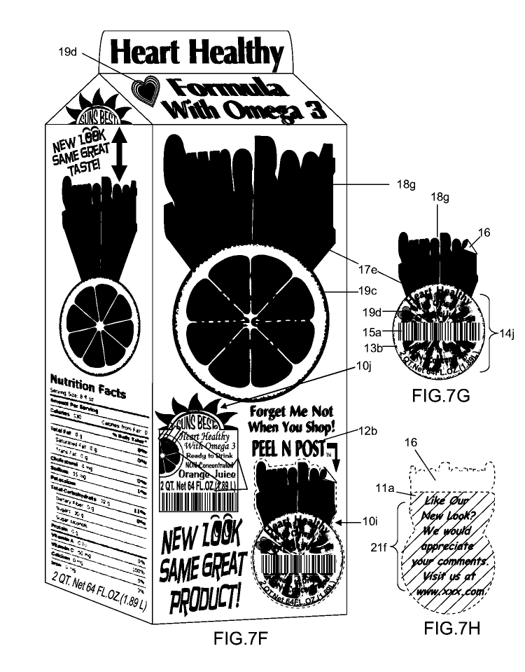

FIGS. 7A through 7H

FIGS. 7A,B,C, and D illustrate the ability of an embodiment at least partly to take on a product related shape. Within in these illustrations the upper portion of the future product identifiers take on the shape of the product's trademark 17d: a sunshine.

FIGS. 7G and H illustrate a future product identifier taking on two or more product related shapes. The product brand “Suns Best” 18g is incorporated into its trademark 17e; the upper portion of the embodiment includes the sun's rays, while the remainder of the embodiment is shaped like that of an orange slice 19c (a product related image) which is ghosted (13b) behind additional product identifying indicia (14j in FIG. 7G).

FIGS. 7E and 7F illustrate perspective front views of the simulated and corresponding consumer product Heart Healthy 19d Orange Juice produced and marketed by Suns Best 18g. FIG. 7F illustrates FIG. 7E after the producer has made a primary product label change such that the primary product label takes on a “New (shelf) Look”. The first (prior) primary product label is shown in FIG. 7E, and the redesigned second (new) primary product label is shown in FIG. 7F.

FIG. 7A, showing a front surface view of the future product identifier created for Suns Best 18g Heart Healthy 19d with Omega 3 Orange Juice (product illustrated in FIG. 7E), illustrates the incorporation of several non-text aids simplifying product re-identification for its consumers. The upper portion of the embodiment is cut and shaped like that of the products trademark 17d, a sun shine. Included within this uniquely shaped area is the instructive insignia “Peel N Post” 12a and the brand name 18g Suns Best. The remaining portion of this embodiment is in the basic form of a square, and like its corresponding product (FIG. 7E), includes the illustrations of an orange slice 19c and heart 19d. These non-text illustrations direct a consumer to their product of choice in a simple, fast, and effective manner. Also included within this area is text stating additional specific product identifying information 14j: “Heart Healthy With Omega 3”, “Ready to Drink”, “NON-Concentrated”, and “Orange Juice”, “2 QT. Net 64 FL OZ. (1.89 L)”, offering further assistance in product re-identification. Moreover, the embodiment includes an optional product Universal Product Code (UPC) 15a and non adhesive area 16 for simplifying identifier detachment from the product container.

FIG. 7B, the back surface of the identifier illustrated in FIG. 7A, illustrates the option to encourage a consumer to try yet another product marketed by the producer. This enticement 21d informs consumers with stomach acid problems to try the producer's (i.e., “Suns Best” 18g) “Low Acid” Orange Juice. Non-text illustrations can be included on the back surface as well, such as the orange slice 19c and the unhappy upset stomach 19e. Whereas the producer used the heart shape (19d in FIGS. 7A, E, and F) to guide a consumer to their “Heart Healthy” orange juice product, the producer has now replaced the heart 19d with an illustration of an unhappy upset stomach 19e to aid a consumer in locating a new product of choice. This enticement upon the back surface of an identifier illustrates the option to place indicia upon an embodiment's back surface prior to the re-usable adhesive application 11a. One can note the placement 10g of the identifier illustrated in FIGS. 7A and B upon its corresponding consumer product in FIG. 7E.

FIGS. 7C and 7D illustrate a second product identifier for placement 10h upon the producer's “Heart Healthy” orange juice product (illustrated in FIG. 7E). This second product identifier (FIGS. 7C and D) is not for re-identification of the consumer product it is being placed 10h upon, but instead is a consumer enticement and a future product identifier for yet another product offered by the producer; their “Low Calorie Light and Lively” 19f orange juice product. It is noted that products of other producers and other product lines can alternatively be promoted, for example, on the back surface of the first identifier or using a second identifier.

FIGS. 7C illustrates, similar to other embodiments in the drawings, the instructive insignia 12a, the non-adhesive area 16 for removal simplification, inclusion of the products UPC bar code 15a, the product brand name 18g, specific product identification information 14k for re-identification of the product for which the identifier is intended, a product related image 19c (the orange), and a second product related image 19f. Here, instead of using the heart 19d (FIG. 7A) for the producer's “Heart Healthy” juice or the unhappy upset stomach 19e (FIG. 7B) for the producers “Low Acid” orange juice, the second product related image illustrated is two light and lively people 19f to further simplify a consumers ability to re-identify Suns Best 18g “Low Calorie Light and Lively” product within their line of orange juices.

FIG. 7D, a perspective back view of the product identifier displayed in FIG. 7C, illustrates the option of placing additional indicia in the form of a slogan 21e “Striving to Meet All Our Customers Needs!” upon the embodiment's back surface prior to the application of adhesive 11a.

FIG. 7E is an environmental front view of the consumer product corresponding to the product identifiers illustrated in FIGS. 7A, B, C, and D. Within this illustration one can note under the statement “Forget Me Not When You Shop” (printed directly upon the product's primary label) the placement 10g of the product identifier illustrated in FIGS. 7A and B. This is the identifier intended for re-identification of the product (FIG. 7E) in the product container on which it is posted. The product identifier (illustrated in FIGS. 7C and D), which is intended to entice a consumer to purchase another product within the producer's line of orange juices, can be placed 10 h under the statement “Have you tried our Low Calorie Light & Lively?” (also printed directly upon the product's primary label). The inclusion of the embodiment illustrated in FIGS. 7C and D placed 10h upon the product illustrated in FIG. 7E illustrates the ability to encourage the sale of other products through the use of future product identifiers.

FIG. 7F is a near actual size environmental front view of the consumer product illustrated in FIG. 7E following a change in the primary product label such that the product is given a new shelf look. A shopper who purchased the product when the product was packaged using the previous (“first”) primary product label will have the outdated (“first”) identifier that corresponds not with the new (“second”) primary product label but with the previous (“first”) primary product label. The shopper would thus not be able to easily locate the desired consumer product at the store because the desired product is not packaged using a primary product label that corresponds with the shopper's (“first”) identifier. He or she might be frustrated and give up looking for the exact product desired, or might even settle on a competitor's product. To avoid loss of sales and goodwill during such a transition, the producer has placed image 10j upon this new (“second”) primary product label as an illustration of the product's previously-matching (“first”) product identifier (FIG. 7A) to allow the shopper to locate the product even in its new packaging. A ghosted arrow directing the consumer to the product's “new look” and removable new (“second”) product identifier (illustrated in FIGS. 7G and H) corresponding to the new look are seen placed 10i upon the product container's (FIG. 7F) lower right hand corner. Next time, the shopper will be able to use the new detachable (“second”) identifier at 10i corresponding with the new (“second”) primary label to locate the desired product.

FIG. 7G is the front surface of the future product identifier for the product illustrated in FIG. 7F, and FIG. 7H is the perspective back view of the product identifier displayed in FIG. 7G. FIG. 7H illustrates the placement of indicia upon the embodiment's back side in the form of an enticement 21f. This enticement 21f encourages consumers to visit the producer's web site: “Like Our New Look? We would appreciate your comments. Visit us at www.xxx.com”.

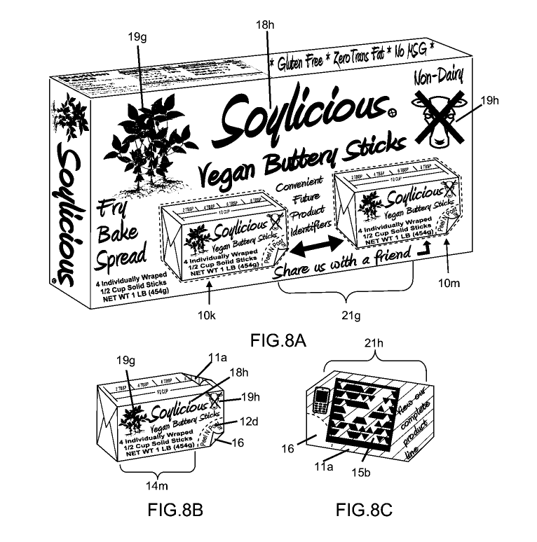

FIGS. 8A, B and C

FIG. 8A is a near actual size environmental front view of a simulated consumer product illustrating placement 10k and 10m of two corresponding and duplicate future product identifiers (FIGS. 8B&C). Text upon the primary product label (FIG. 8A) entices 21g consumers to promote this specific consumer product by passing along the additional identifier provided upon the product 10m to, for example, an acquaintance, friend, or family member.

FIG. 8B, a perspective front view of the future product identifier created for the consumer product illustrated in FIG. 8A, illustrates the ability of an embodiment to take on that of a unique or novel shape. In this case the identifier (FIGS. 8B and C) is shaped like that of a stick of butter. Consumers may have a preference for a margarine type product in the solid stick form over that of a soft spread form often sold in a tub-like container. This unique product related shape not only directs the consumer to refrigerated margarine products but continues to narrow the search to those sold in solid stick form. In addition to the shape of the identifier indicating the product's form, specific product identifying information 14m includes text also indicating the product form, quantity and weight. FIG. 8B also illustrates the inclusion of the product brand name “Soylicious” 18h presented in like font and manner as that upon the product's primary label (FIG. 8A), and further identifies this specific product to be “Vegan Buttery Sticks” presented in a like manner to that upon the product's primary label (FIG. 8A). The inclusion, upon the identifier, of the soy plant 19g and the crossed out cow 19h images offer additional product information and aid for specific product re-identification. Finally the instructive insignia 12d “Peel N Post” located upon the identifier's lower right corner encourages its removal and use resulting in consumer product loyalty.

FIG. 8C is a perspective back view of the embodiment displayed in FIG. 8B and illustrates a consumer enticement 21h in the form of a consumer scan able (machine readable 15b) code. This particular machine readable code 15b is referred to as a “tag reader” and allows the producer to offer those consumers with capable electronic devices and the corresponding software a quicker and more direct link to company information or their web site. This illustrates yet another method to reinforce brand awareness and consumer loyalty. FIG. 8C also illustrates the reusable adhesive application 11a allowing the consumer the ability to repost the identifier to a location of their choice and the non-adhesive 16 area for removal and re-posting simplification.

It is noted that in FIG. 8A, as well as with the drawings in other figures discussed above, the identifier preferably does not provide an exact duplicate of the indicia of the primary product labels. If, for example, an identifier were a “carbon copy” of the primary product label on the product container, identifying indicia on the identifier would likely be difficult if not impossible to read by a shopper. This is due to the size of the identifiers relative to their corresponding primary product labels, and the small size of some identifying indicia on the primary product label. For example, the primary product label often includes a logo that is relatively large and noticeable to grab the consumer's attention. But some details about the product contained in the product container (such as quantity, method of packaging, physical form, etc.) tend to be much smaller than the logo. Although such smaller-sized details are nonetheless generally readable by most consumers when they are on the primary product label, these details would become considerably smaller if they are shrunk down even further on an identifier that merely provides a photocopy image of the primary product label (with all indicia duplicated “to scale”). This could make such details unreadable and diminish the ability of the shopper to easily recall and identify the particular product desired.

To enable the shopper to read identifying information on the identifier, indicia are preferably selectively replicated in a not-to-scale fashion. For example, quantity information (which tends to be printed using a small type on the product label) is not shrunk to the same degree (if at all) as the logo is shrunk on the removable identifier. (It is noted that indicia can be otherwise replicated identically except for the size difference resulting from the shrinkage. However, the indicia can additionally be modified and rearranged to enhance presentation without diminishing the ability of the identifier to impart identifying information.) Alternatively, a distinctive indicator associated with the particular product can be reproduced at the same size on both the primary label and the identifier to aid the visual recognition of the product by the shopper. For example, an image with a distinctive image having an easily-recognized color scheme could be provided on both the primary label and the identifier to aid the shopper. Such an image could have similarities, for example, with the producer's logo, but instead of being associated only with the producer, it could be customized for association with a particular product from the producer. For example, a cow could be incorporated with the producer's logo to represent a dairy product sold by the producer.

It is noted that the primary label and the identifier need not provide all of the same indicia. For example, the physical form (e.g., liquid) of the product might be easily discernable because of the characteristics of the product container, and as such the physical form might be excluded from the primary label. However, because the shopper using the identifier to locate the product likely does not have the product container with him/her, the identifier might indicate the physical form to direct the shopper's attention to particular product containers. Analogously, cautionary information and safety warnings could be provided on the primary label but left off the identifier because the warnings do not apply until the shopper has purchased the product.

It is also noted that the terms duplicate, replicate, replica, etc., do not necessarily require exact copying of relevant portions, but rather allow for minor or insubstantial differences. For example, indicia being shrunk and copied are preferably scaled down and replicated faithfully so that they are readily recognizable as representative of the copied indicia. However, the replicas/duplicates can be either exact copies or copies with minor differences that do not significantly diminish their recognizability or usefulness. The exactness with which indicia are duplicated/replicated can depend on appropriateness for particular situations. For example, on a second (redesigned) primary product label it is preferable to provide a very faithful duplicate image of the first identifier (corresponding with the first primary product label) so as to enhance recognizability.

It is further noted that the identifiers are preferably securable to the product containers via an adhesive applied to a portion of the identifier, but identifiers may alternatively be secured to product containers without using adhesive. For example, an identifier can be provided in a “pocket” formed in the product label or packaging, or can be removably attached to the product label or packaging via perforations without also being “stuck” to the product container. Additionally, although in a preferred version identifiers have non-drying adhesive to allow them to be conveniently re-attachable to one or more other surfaces after being removed from a product container, the identifiers need not be provided with adhesive (non-drying or otherwise). For example, the identifiers can be configured for insertion into a “reminder journal” designed for holding and organizing identifiers, analogous to the addition of photographs to a photograph album.

Although the present invention has been described in detail with multiple example embodiments, those skilled in the art will understand that various changes, substitutions, and alterations herein may be made without departing from the spirit and scope of the invention in its broadest form. Therefore, the foregoing embodiments are to be considered, in all respects, illustrative rather than limiting on the invention described herein. Scope of the invention is thus indicated by the appended claims rather than by the foregoing description, and all changes that come within the meaning and range of equivalency of the claims are intended to be embraced therein.

What is claimed is:

1. A method of building consumer loyalty and aiding specific product identification, the method including the steps of:
a) packaging a first consumer product in a product container, the product container containing a quantity of the first consumer product;
b) marketing the consumer product to consumers under a brand associated with the first consumer product;
c) printing or affixing a first product label on the product container, the first product label having first product label indicia:
1) of a logo identifying the brand;
2) identifying the first consumer product; and
3) indentifying the quantity of the first consumer product contained in the product container;
d) removably securing a first identifier to the product container using a non-drying adhesive, the first identifier:
1) being configured to be reaffixable to other surfaces after it is detached from the product container;
2) being substantially smaller than the first product label; and
3) including shrunk replicas of the indicia of the logo and the indicia identifying the quantity from the first product label, wherein the replicas are shrunk in a not-to-scale fashion such that the indicia of the logo and the indicia identifying the quantity are shrunk to different degrees on the first identifier;
e) making the product container available for sale to consumers, the product container having:
1) the first consumer product packaged therein;
2) the first product label printed or affixed thereon; and
3) the first identifier removably affixed thereon.

2. The method of claim 1 wherein the indicia identifying the quantity is shrunk to a lesser degree than the indicia of the logo so as to help consumers more easily identify the product container containing the particular quantity of the first consumer product.

3. The method of claim 1 wherein the indicia identifying the quantity replicated on the first identifier is not shrunk, such that the indicia identifying the quantity on the first identifier is at least substantially the same size as the indicia identifying the quantity of the consumer product on the first product label.

4. The method of claim 1 wherein the first identifier is removably attached to the first product label via perforations.

5. The method of claim 1 further including a second identifier, the second identifier:
a) at least substantially replicating the first identifier; and
b) being removably affixed to the product container such that the second identifier is reaffixable to other surfaces after it is detached from the product container, whereby a first consumer purchasing the first consumer product can share the second identifier with a second consumer to aid the second consumer in identifying the first consumer product.

6. The method of claim 1 further including a second identifier removably affixed to the product container, the second identifier including indicia promoting a second consumer product distinct from the first consumer product.

7. The method of claim 1,
a) further including the steps of:
1) substantially modifying the first product label to produce a redesigned second product label having a substantially different appearance from the first product label, the second product label having second product label indicia:
(i) of a logo identifying the brand;
(ii) identifying the first consumer product; and
(iii) indentifying the quantity of the first consumer product contained in the product container;
2) substantially modifying the first identifier to produce a second identifier corresponding to the second product label, the second identifier:
(i) being substantially smaller than the second product label; and
(ii) including shrunk replicas of the indicia of the logo and the indicia identifying the quantity from the second product label, wherein the replicas are shrunk in a not-to-scale fashion such that the indicia of the logo and the indicia identifying the quantity are shrunk to different degrees on the second identifier;
3) selling the product container to consumers, the product container having:
(i) the first consumer product packaged therein;
(ii) the second product label printed or affixed thereon; and
(iii) the second identifier removably affixed thereon;
b) wherein the second product label further includes an image at least substantially replicating the first identifier so as to aid consumers in specifically re-identifying the product container using the first identifier despite the replacement of the first product label with the redesigned second product label on the product container.

8. The method of claim 1 wherein on the second identifier the indicia identifying the quantity is shrunk to a lesser degree than the indicia of the logo so as to help consumers more easily identify the product container containing the particular quantity of the first consumer product.

9. The method of claim 1 wherein:
a) the first product label does not include indicia identifying a physical form of the first consumer product; and
b) the first identifier includes indicia identifying the physical form of the first consumer product, wherein the indicia identifying the physical form of the first consumer product indicates that the physical form is a physical form selected from the group consisting of liquid, solid, aerosol, powder, frozen, canned, capsule, tablet, and concentrated.

10. The method of claim 1 wherein:
a) the first product label further includes indicia identifying the physical form of the first consumer product; and
b) the first identifier further includes a shrunk replica of the first product label indicia identifying the physical form, wherein the first product label indicia identifying the physical form is shrunk to a lesser degree than the first product label indicia of the logo.

11. The method of claim 10 wherein the indicia identifying the physical form on the first identifier is at least substantially the same size as the first product label indicia identifying the physical form of the consumer product.

12. The method of claim 1 wherein a shape of the first identifier at least substantially matches a two-dimensional representation of an object with which the first consumer product is used.

13. The method of claim 1 wherein a shape of the first identifier at least substantially matches a two-dimensional representation of the consumer product.

14. The method of claim 1 wherein a shape of the first identifier at least substantially matches a two-dimensional representation of the product container.

15. The method of claim 1 wherein a shape of the first identifier at least substantially matches an outer-edge outline of the indicia of the logo.

16. The method of claim 1 wherein:
a) the first identifier includes a first identifier front side and an opposing first identifier back side;
b) the shrunk replicas of the indicia of the logo and the indicia identifying the quantity are provided on the first identifier front side; and
c) the first identifier back side at least substantially replicates the indicia of the first identifier front side in a second language.

17. The method of claim 1 wherein:
a) the first identifier includes a first identifier front side and an opposing first identifier back side;
b) the shrunk replicas of the indicia of the logo and the indicia identifying the quantity are provided on the first identifier front side; and
c) the first identifier back side includes indicia promoting a second consumer product distinct from the first consumer product.

18. The method of claim 1 wherein:
a) the first identifier includes a first identifier front side and an opposing first identifier back side;
b) the shrunk replicas of the indicia of the logo and the indicia identifying the quantity are provided on the first identifier front side; and
c) the first identifier back side includes indicia of a slogan associated with the brand or the consumer product.

19. The method of claim 1 wherein:
a) the first identifier includes a first identifier front side and an opposing first identifier back side;
b) the shrunk replicas of the indicia of the logo and the indicia identifying the quantity are provided on the first identifier front side; and
c) the first identifier back side includes indicia directing consumers to an Internet website associated with the brand or the consumer product.

20. The method of claim 1 wherein:
a) the first identifier includes multiple panels folded onto each other when affixed to the product container, with:
1) a first identifier primary panel of the first identifier initially viewable when the first identifier is affixed to product container before being detached from the product container by a consumer;
2) a first identifier secondary panel of the first identifier not viewable until after the first identifier is detached from the product container by a consumer; and
3) a first identifier tertiary panel of the first identifier not viewable until after the first identifier is detached from the product container by a consumer, the first identifier tertiary panel having the non-drying adhesive configured to removably affix the first identifier to the product container; and
b) the shrunk replicas of the indicia of the logo and the indicia identifying the quantity are provided on the first identifier primary panel of the first identifier.

21. The method of claim 20 wherein at least a majority of the indicia on the first identifier primary panel is replicated on the first identifier secondary panel in a second language.

22. The method of claim 20 wherein the first identifier secondary panel includes indicia making the first identifier secondary panel usable as a coupon for a subsequent purchase of the consumer product.

23. The method of claim 20 wherein the first identifier tertiary panel of the first identifier includes indicia promoting a second consumer product distinct from the first consumer product.

24. The method of claim 20 wherein the first identifier tertiary panel of the first identifier at least substantially replicates a majority of the indicia on the first identifier primary panel.

25. The method of claim 20 wherein the first identifier tertiary panel of the first identifier includes indicia of a slogan associated with the brand or the consumer product.

26. The method of claim 20 wherein the first identifier tertiary panel of the first identifier includes indicia directing consumers to an Internet website associated with the brand or the consumer product.

27. The method of claim 20 wherein the first identifier tertiary panel of the first identifier includes indicia expressing appreciation for consumer loyalty.

28. A method of building consumer loyalty and aiding specific product identification,
a) the method including the steps of:
1) procuring a first consumer product in a product container, the product container containing a quantity of the first consumer product;
2) marketing the consumer product to consumers under a brand associated with the first consumer product;
3) procuring a first product label printed or affixed directly on the product container, the first product label having first product label indicia identifying:
(i) the first consumer product;
(ii) the brand of the first consumer product; and
(iii) the quantity of the first consumer product;
4) procuring a first identifier removably affixed to the product container using an adhesive on the first identifier back side, the first identifier:
(i) being substantially smaller than the first product label; and
(ii) having a first identifier front side opposing the first identifier back side, the first identifier front side including shrunk versions of the first product label indicia identifying the first consumer product and the indicia identifying the brand of the first consumer; and
5) making the product container with the first identifier affixed thereon available for sale to consumers;
b) wherein the indicia on the first identifier identifying the first consumer product is shrunk less than the indicia identifying the brand of the first consumer product.

29. The method of claim 28 wherein the first identifier further includes a shrunk version of the first product label indicia identifying the quantity of the first consumer product, the shrunk version of the indicia identifying the quantity being shrunk less than the indicia identifying the brand of the first consumer product.

30. The method of claim 28 wherein a first identifier edge is attached to a first product label edge via perforations such that the first identifier is detachable from the first product label by pulling the first identifier away from the perforations.

31. The method of claim 28 wherein the first identifier back side includes a duplicate of at least a majority of the indicia on the first identifier front side in a second language.

32. The method of claim 28 wherein the first identifier back side includes indicia of a slogan associated with the brand or the consumer product.

33. The method of claim 28 wherein the first identifier back side includes indicia directing consumers to an Internet website.

34. The method of claim 28 wherein a shape of the first identifier at least substantially matches a two-dimensional representation of an object with which the first consumer product is used.

35. The method of claim 28 wherein:
a) the first identifier includes multiple panels folded onto each other when affixed to the product container, with:
1) a first identifier primary panel of the first identifier viewable when the first identifier is affixed to product container;
2) a first identifier secondary panel of the first identifier not viewable until the first identifier is detached from the product container by a consumer; and
3) a first identifier tertiary panel of the first identifier having the adhesive used to affix the first identifier to the product container;
b) both of the primary panel and the tertiary panel of the first identifier include shrunk replicas of:
1) the first product label indicia identifying the brand of the first consumer product;
2) the quantity of the first consumer product; and
3) the physical form of the first consumer product; and
c) on the primary panel and the tertiary panel, the indicia identifying the quantity of the first consumer product and the indicia identifying the physical form of the first consumer product are shrunk less than the indicia identifying the brand.

36. A method of building consumer loyalty and aiding specific product identification, the method including the steps of:
a) procuring a first consumer product packaged in a product container, the product container containing a quantity of the first consumer product, wherein:
1) a first product label is printed or affixed on the product container, the first product label having first product label indicia identifying:
(i) the brand;
(ii) the first consumer product contained in the product container; and
(iii) the quantity of the first consumer product contained in the product container; and
2) a first identifier is removably secured to the product container such that the first identifier is reaffixable to other surfaces after it is detached from the product container, the first identifier:
(i) being substantially smaller than the first product label; and
(ii) including shrunk replicas of selected first product label indicia in a not-to-scale fashion, wherein the indicia identifying the quantity of the first consumer product is shrunk less than the indicia identifying brand;
b) marketing the consumer product to consumers under a brand associated with the first consumer product; and
c) making the product container available to consumers, the product container having:
1) the first consumer product packaged therein;
2) the first product label printed or affixed thereon; and
3) the first identifier removably secured thereto.

37. The method of claim 36 wherein:
a) the identifier includes a shrunk replica of the indicia identifying the quantity of the first consumer product; and
b) the indicia identifying the quantity on the first identifier is at least substantially the same size as the indicia identifying the quantity on the first product label.

38. The method of claim 36 wherein a shape of the first identifier at least substantially matches a two-dimensional representation of an object with which the first consumer product is used.

39. The method of claim 36 , wherein:
a) the first identifier includes a first identifier front side and an opposing first identifier back side;
b) the shrunk replicas of the selected product label indicia are provided on the first identifier front side; and
c) the first identifier back side includes indicia promoting a second consumer product distinct from the first consumer product.

40. The method of claim 36, wherein:
a) the first identifier includes a first identifier front side and an opposing first identifier back side;
b) the shrunk replicas of the selected product label indicia are provided on the first identifier front side; and
c) the first identifier back side includes indicia replicating at least a majority of the indicia on the first identifier front side in a second language.

41. The method of claim 36 further including a second identifier, the second identifier:
a) at least substantially duplicating the first identifier; and
b) being removably affixed to the product container using a non-drying adhesive such that the second identifier is reaffixable to other surfaces after it is detached from the product container.

42. The method of claim 36 further including a second identifier removably affixed to the product container, the second identifier including indicia promoting a second consumer product distinct from the first consumer product.

43. The method of claim 36, wherein:
a) the first identifier includes multiple panels folded onto each other when affixed to the product container, with:
1) a first identifier primary panel of the first identifier initially viewable when the first identifier is affixed to product container; and
2) a first identifier secondary panel of the first identifier not viewable until the first identifier is detached from the product container by a consumer;
b) the majority of the indicia on the first product label is duplicated on the first identifier primary panel; and
c) a majority of the indicia on the first identifier primary panel is duplicated on the first identifier secondary panel in a second language.

44. The method of claim 43 wherein a tertiary panel of the first identifier includes:
a) a non-drying adhesive configured to removably secure the first identifier to the product container; and
b) a replica of a majority of the indicia on the first identifier primary panel.

45. The method of claim 43 wherein a tertiary panel of the first identifier includes at least one of:
a) indicia of a slogan associated with the brand or the consumer product; and
b) indicia directing consumers to an Internet website associated with the brand or the consumer product.

46. A method of building consumer loyalty and aiding specific product identification,
a) the method including the steps of:
1) procuring a first consumer product in a product container, the product container containing a quantity of the first consumer product;
2) marketing the consumer product to consumers under a brand associated with the first consumer product;
3) procuring a first product label printed or affixed on the product container, the first product label having first product label indicia:
(i) of a logo identifying the brand;
(ii) identifying the first consumer product in the product container; and
(iii) indentifying the quantity of the first consumer product contained in the product container;
4) procuring a first identifier removably secured to the product container using a non-drying adhesive such that the first identifier is reaffixable to other surfaces after it is detached from the product container, the first identifier:
(i) being substantially smaller than the first product label;
(ii) including shrunk replicas of the first product label indicia of the logo and the indicia identifying the first consumer product;
5) making the product container with the first consumer product packaged therein and the first identifier removably secured thereto available for sale to consumers;
6) substantially modifying the first product label to produce a redesigned second product label having a substantially different appearance from the first product label, the second product label having second product label indicia:
(i) of a logo identifying the brand;
(ii) identifying the first consumer product; and
(iii) indentifying the quantity of the first consumer product contained in the product container;
7) substantially modifying the first identifier to produce a redesigned second identifier corresponding to the redesigned second product label, the second identifier:
(i) being substantially smaller than the second product label;
(ii) including shrunk replicas of the second product label indicia of the logo and the indicia identifying the first consumer product;
8) making the product container with the first consumer product packaged therein available for sale to consumers, the product container having:
(i) the second product label printed or affixed thereon; and
(ii) the second identifier removably secured thereto;
b) wherein the second product label further includes a non-removable image at least substantially duplicating the first identifier to aid consumers in specifically re-identifying the product container using the first identifier despite the replacement of the first product label with the redesigned second product label on the product container.
